(19) United States
(12) Patent Application Publication
(10) Pub. No.: US 2026/0138250 A1
(43) Pub. Date: May 21, 2026

(54) HYDRAULIC QUICK COUPLER DECOMPRESSION TOOL FOR FLAT FACE MALE COUPLERS

(71) Applicant: Preston Haines Thomas, San Luis Obispo, CA (US)

(72) Inventor: Preston Haines Thomas, San Luis Obispo, CA (US)

(21) Appl. No.: 19/385,958

(22) Filed: Nov. 11, 2025

Related U.S. Application Data
(60) Provisional application No. 63/720,865, filed on Nov. 15, 2024.

(51) Int. Cl. B25B 27/02; F15B 21/00; F16L 37/23; F16L 37/36

(52) U.S. Cl. CPC B25B 27/023; F15B 21/005; F16L 37/23; F16L 37/36

(57) ABSTRACT

A system, method, and apparatus for opening a coupler and releasing pressure in a hydraulic circuit comprises a tool body, a ring shaped gasket inside the tool body, an internal spring configured inside the tool body configured to exert pressure on the ring shaped gasket, a sleeve operably connected to the tool body, a threaded receiver, and a threaded plunger engaged in the threaded receiver.

### CROSS-REFERENCE TO RELATED PATENT APPLICATIONS

This patent application claims the priority and benefit under 35 U.S.C. § 119(e) of U.S. Provisional Patent Application Ser. No. 63/720,865 filed Nov. 15, 2024, entitled “HYDRAULIC QUICK COUPLER DECOMPRESSION TOOL FOR FLAT FACE MALE COUPLERS.” U.S. Provisional Patent Application Ser. No. 63/720,865 is herein incorporated by reference in its entirety.

### TECHNICAL FIELD

Embodiments are generally related to the field of tools. Embodiments are also related to the field of tools for hydraulic fittings. Embodiments are further related to the field of tools for tractors, skid steers, and excavators. Embodiments are further related to tools for hydraulic decompression for flat faced ISO 16028 male couplers.

### BACKGROUND

Hydraulic-based heavy machinery such as tractors, skid steers, and excavators use quick couplers for connecting to the hydraulic systems. In such systems, power can be transmitted and controlled with a fluid under pressure. The fluid under pressure is contained in a closed loop, so that applying pressure at one point can transfer the associated power to another point in the closed loop. In such systems quick couplers are used to allow an operator to quickly and easily connect or disconnect hydraulic lines.

One example of such a coupler is the male hydraulic quick coupler, which is an International Standards Organization (ISO) 16028 conforming coupler. This type of coupler 100 has a flat face 110, and is illustrated in FIG. 1A, labeled as prior art.

Quick couplers are meant to be easy to use, so that users can quickly connect or disconnect lines to a hydraulic pressure circuit. However, in practice, the hydraulic circuit is under pressure. As such, it can be very difficult to attach a hydraulic line using a quick connect if there is pressure still in the line.

One solution is to release the pressure in the hydraulic circuit before attempting to connect a line. However, the quick coupler has a flat face and small area to compress, which makes it very difficult to release the pressure, particularly by hand.

As such, there is a need in the art for simple, cost effective systems, methods, and tools for releasing pressure via a quick coupler, as disclosed herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a tool.

It is another aspect of the disclosed embodiments to provide a tool for quick connect couplers.

It is another aspect of the disclosed embodiments to provide a tool for releasing pressure in a hydraulic circuit via a quick connect coupler.

It is another aspect of the disclosed embodiments to provide a tractor relief tool.

It is another aspect of the disclosed embodiments to provide a flat face coupler relief tool.

It is another aspect of the disclosed embodiments to provide a skid steer coupler release tool.

It is another aspect of the disclosed embodiments to provide a method and system or apparatus for interfacing with a quick connect coupler to release pressure.

In an exemplary embodiment, a tool comprises a tool body, a ring shaped gasket inside the tool body, an internal spring configured inside the tool body configured to exert pressure on the ring shaped gasket, a sleeve operably connected to the tool body, a threaded receiver, and a threaded plunger engaged in the threaded receiver. In an embodiment, the tool further comprises a threaded port formed in the threaded receiver configured to accept the threaded plunger. In an embodiment, the tool further comprises a bleed port form in the tool body. In an embodiment, the tool further comprises a stop peg formed in the tool body. In an embodiment, the sleeve further comprises a peg cutout. In an embodiment, the tool further comprises a series of bearings configured in a ring along an interior circumference of the tool body. In an embodiment, the threaded plunger further comprises a handle attached to a rod. In an embodiment, the rod comprises a threaded section and a plunger head at a distal end. In an embodiment, the tool further comprises a flattened face on an end of the plunger head. In an embodiment, the tool is configured to engage a flat faced ISO 16028 male coupler.

In an embodiment a device comprises a tool configured to engage a flat faced ISO 16028 male coupler, the tool comprising a tool body, a ring shaped gasket inside the tool body, a sleeve operably connected to the tool body, a receiver in the tool body, and a plunger engaged in the receiver. In an embodiment, the device further comprises a threaded port formed in the receiver configured to accept a threaded portion of the plunger. In an embodiment, the device further comprises a bleed port formed in the tool body. In an embodiment, the sleeve further comprises a peg cutout. In an embodiment, the device further comprises a stop peg formed in the tool body. In an embodiment, the device further comprises a series of bearings configured in a ring along an interior circumference of the tool body. In an embodiment, the device further comprises a flattened face on an end of the plunger.

In an embodiment, a tool comprises a tool body, a ring shaped gasket inside the tool body, an internal spring configured inside the tool body configured to exert pressure on the ring shaped gasket, a sleeve operably connected to the tool body, and a threaded receiver. In an embodiment, the tool further comprises a threaded plunger configured to engage the threaded receiver, the threaded plunger further comprising a handle attached to a rod, a threaded section of the rod, and a plunger head at a distal end of the rod. In an embodiment, the tool is configured to engage a flat faced ISO 16028 male coupler.

The aforementioned aspects and other objectives and advantages can now be achieved as described herein.

### BRIEF DESCRIPTION OF THE FIGURES

The accompanying figures, in which like reference numerals refer to identical or functionally similar elements throughout the separate views and which are incorporated in, and form a part of the specification, further illustrate the embodiments and, together with the detailed description, serve to explain the embodiments disclosed herein.

FIG. 1A depicts a view of a prior art quick connect coupler, in accordance with the disclosed embodiments;

FIG. 2A depicts a side elevation view of a tool, in accordance with the disclosed embodiments;

FIG. 2B depicts a front elevation view of a tool in a retracted position, in accordance with the disclosed embodiments;

FIG. 2C depicts a front elevation view of a tool in an extended position, in accordance with the disclosed embodiments;

FIG. 2D depicts a front elevation view of a tool in an extended position, in accordance with the disclosed embodiments;

FIG. 2E depicts a rear elevation view of a tool, in accordance with the disclosed embodiments;

FIG. 3 depicts aspects of a threaded plunger, in accordance with the disclosed embodiments;

FIG. 4A illustrates a side perspective view of the tool with the threaded plunger in a retracted position, in accordance with the disclosed embodiments;

FIG. 4B illustrates a side perspective view of the tool with the threaded plunger in an extended position, in accordance with the disclosed embodiments;

FIG. 5A illustrates view of the tool and a quick coupler separated, in accordance with the disclosed embodiments;

FIG. 5B illustrates view of the tool and a quick coupler connected, in accordance with the disclosed embodiments; and

FIG. 6 depicts steps associated with a method for opening a coupler and releasing pressure in a hydraulic circuit with a tool, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context. All aspects of the various embodiments can be interchangeable with aspects disclosed in other embodiments, and/or can be incorporated in other embodiments.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

Hydraulic quick couplers are known for building up excess pressure which makes them difficult to connect by hand. Embodiments are directed to a device/tool meant to securely clamp onto the male hydraulic quick coupler, for example, an ISO 16028 male hydraulic quick coupler. Once the tool is secured to the hydraulic quick coupler, a threaded plunger can be used to release the pressure by pressing a center release plug, in the center of the quick coupler. This tool is meant to relieve any built-up pressure in the hydraulic line of the tractor or implement, so the operator can easily connect hydraulic hoses via the quick coupler, by hand.

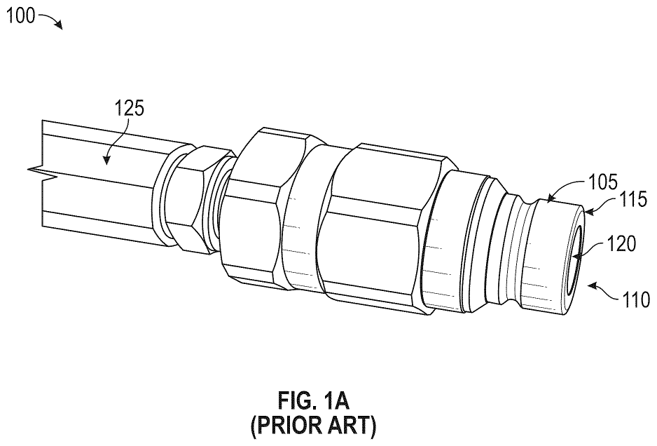

FIG. 1A illustrates an exemplary prior art male coupler 100 (a “quick coupler” or “male quick coupler”). The disclosed embodiments can be used to release pressure in a hydraulic circuit fitted with such a male coupler. The quick coupler 100 can comprise a neck 105 and a connection face 110. The connection face 110 can further include an outer ring 115, and a center release plug 120. When the center release plug 120 is not depressed, the coupler 100 is “closed”, allowing the hydraulic circuit to remain under pressure. When the release plunger 120 is depressed, the coupler is “open” meaning fluid can flow through the coupler. In normal operation a female fitting, for example associated with a fluid line 125, can be engaged to the coupler 100. When the female fitting is engaged, the coupler 100 is opened so that fluid, such as hydraulic fluid, can flow into, or out of, the associated hydraulic circuit.

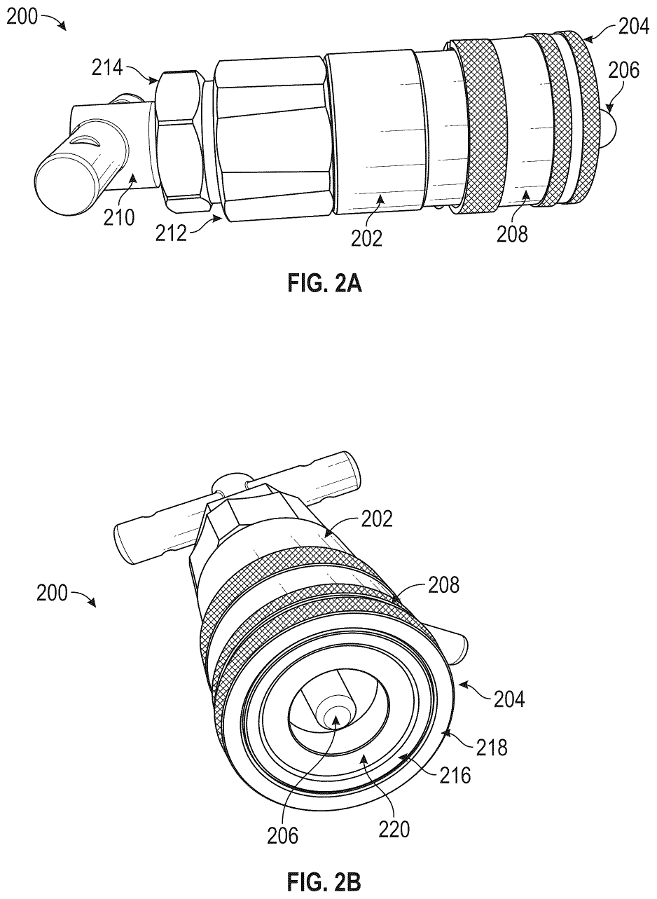

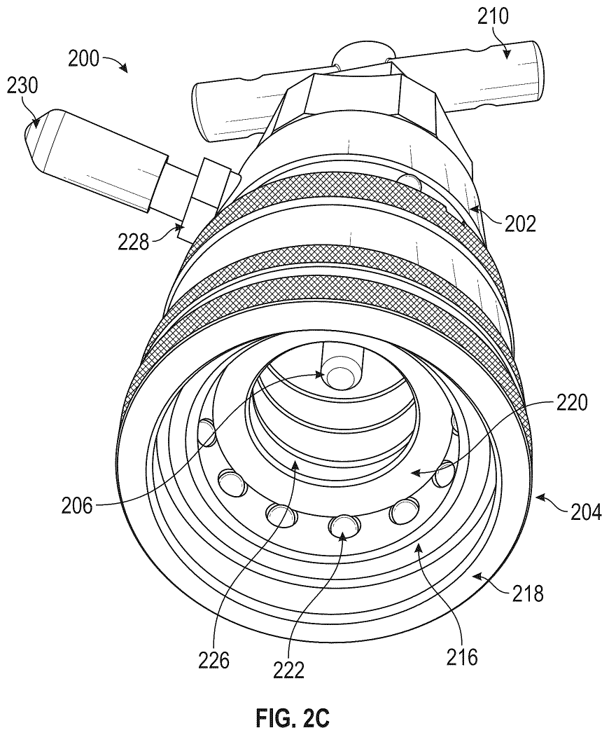

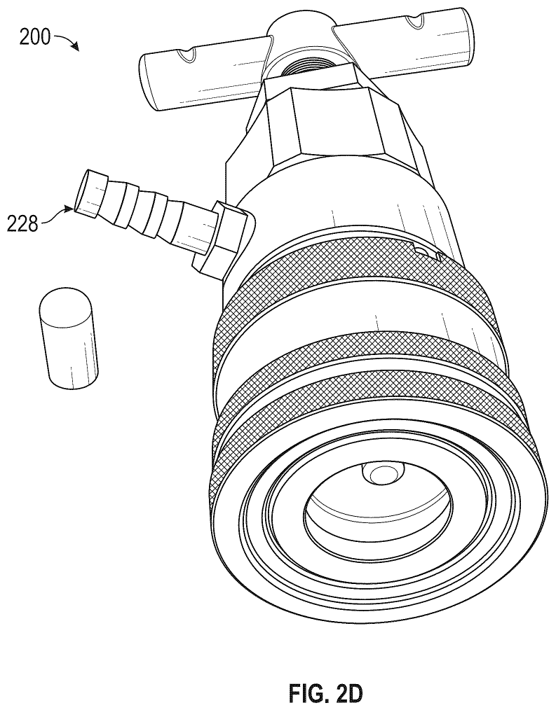

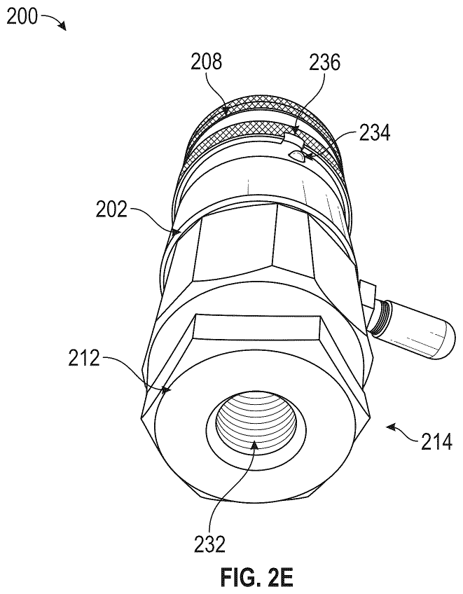

FIG. 2A illustrates a tool 200 in accordance with the disclosed embodiments. The tool 200 generally comprises a cylindrical tool body 202. The operating end 204 of the tool body 202 allows a plunger head 206 associated with a threaded plunger 210 to extend out of the tool body 202 and exert pressure on the release plug 120 in the male coupler 100, in order to release pressure in the male coupler 100. A threaded receiver 212 is attached to the tool body at the operator end 214.

The tool 200 further includes a sleeve 208 which is configured slide along the tool body 202 and engage the male coupler 100. Details of the operation of the tool 200 are further detailed herein.

FIG. 2B illustrates a head on, or front view of the tool 200, in accordance with the disclosed embodiments. In this view, the sleeve 208 is retracted. The rim 216 of the tool body 202 is flush with the rim 218 of the sleeve 208. The tool 200 further includes a ring shaped gasket 220. The gasket 220 is operated via an internal spring as further detailed herein. In this configuration (with the sleeve 208 retracted), the gasket 220 is similarly flush with the rim 216 of the tool body 202 and the rim 218 of the sleeve 208.

This view further illustrates the plunger head 206 oriented centrally in the opening of the ring shaped gasket 220, and internal volume of the tool body 202. The plunger head 206 is the end of the threaded plunger 210 and can be extended or retracted by turning the threaded plunger 210 in the threaded receiver 212.

FIG. 2C illustrates a head on view of the tool 200, with the sleeve 208 extended, in accordance with the disclosed embodiments. In this view, the operating end 204 of the tool 200 is shown with the sleeve 208 extended, in the position it would be in when connected to a male coupler 100.

In this configuration, the sleeve 208 engages the male coupler 100. The rim 218 of the sleeve 208 thus extends away from the rim 216 of the tool body 202. The ring shaped gasket 220 slides backwards and is held in place by a series of bearings 222 installed in a ring along the interior circumference 224 of the tool body 202.

The ring shaped gasket 220 is held against the series of bearings 222 by an internal spring 226. The internal spring 226 spans the length of the tool body 202, and is of a circumference selected to fit along the inner surface of the tool body 202. At one end, the internal spring 226 pushes against the flat backward facing surface of the ring shaped gasket 220. At the other end, the internal spring is braced against the annular shaped surface at the interface of the tool body 202 and threaded receiver 212.

The tool 200 can be engaged to the male coupler 100 by pressing the male coupler into the tool 200, so that the sleeve engages the male coupler 100. Once the male coupler 100 and tool 200 are engaged, the threaded plunger 210 can be extended to exert pressure on the release plug 120. Pushing on the release plug 120 opens the hydraulic circuit. Pressure in the hydraulic circuit can escape via the bleed port 228 (shown with a cap 230). Once the pressure in the hydraulic circuit has been released, the tool 200 can be disengaged from the male coupler 100. FIG. 2D shows the bleed port 228 with the cap 230 removed from the bleed port 228.

FIG. 2E illustrates a rear view of the tool 200, in accordance with the disclosed embodiments. The operator end 214 of the tool body 202 is fitted with a threaded receiver 212. The threaded receiver 212 includes a threaded port 232 configured to accept and engage with the threads on the threaded plunger 210.

The tool 200 further includes a stop peg 234 formed on the tool body 202. The sleeve 208 includes a peg cutout 236. When the tool 200 is retracted, the motion of the sleeve 208 is limited by the stop peg 234. The sleeve 208 can slide along the tool body 202 until the peg cutout 236 reaches the stop peg 234. The location of the stop peg 234, on the tool body 202, is selected such that the rim 216 of the tool body, rim 218 of the sleeve 208, and ring shaped gasket 206 are all flush when the tool 200 is retracted.

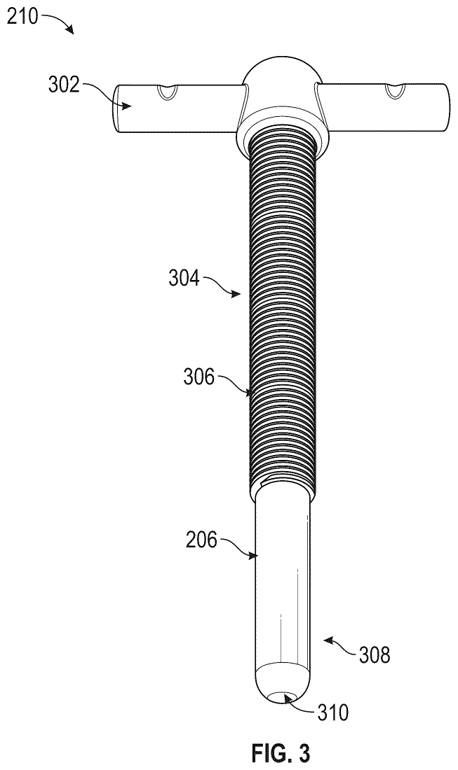

FIG. 3 illustrates the threaded plunger 210, in accordance with the disclosed embodiments. The threaded plunger 210 comprises a handle 302 attached to a rod 304. The rod 304 comprises a threaded section 306 and a plunger head 206 at the distal end 308. The plunger head 206 can be rounded with a flattened face 310, configured to push against the center release plug 120.

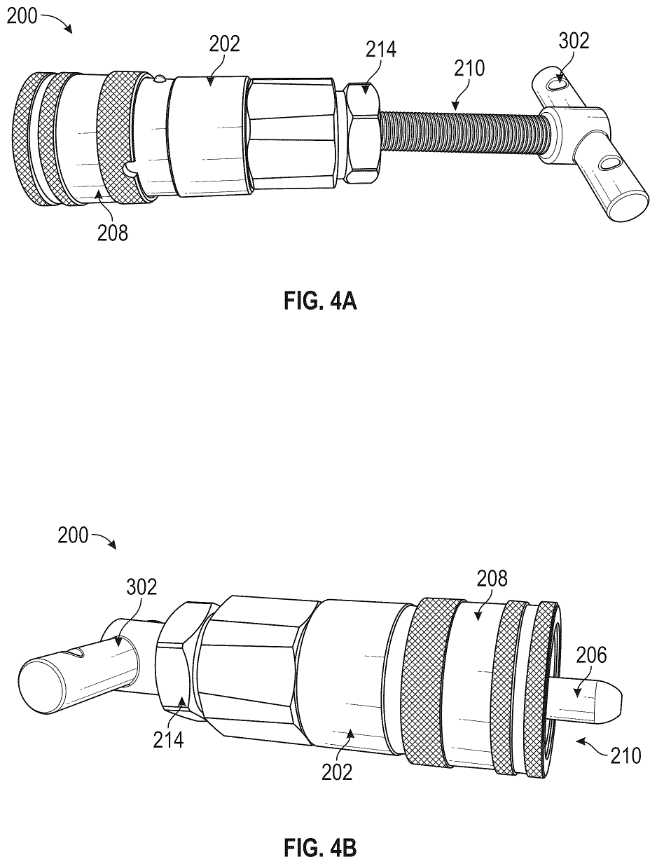

FIGS. 4A and 4B illustrate the tool 200 with the threaded plunger 210 alternatively in a retracted position in FIG. 4A and extended position as illustrated in FIG. 4B. The threaded plunger 210 is configured to extend or retract via rotational engagement with the threaded port 232 in the threaded receiver 212.

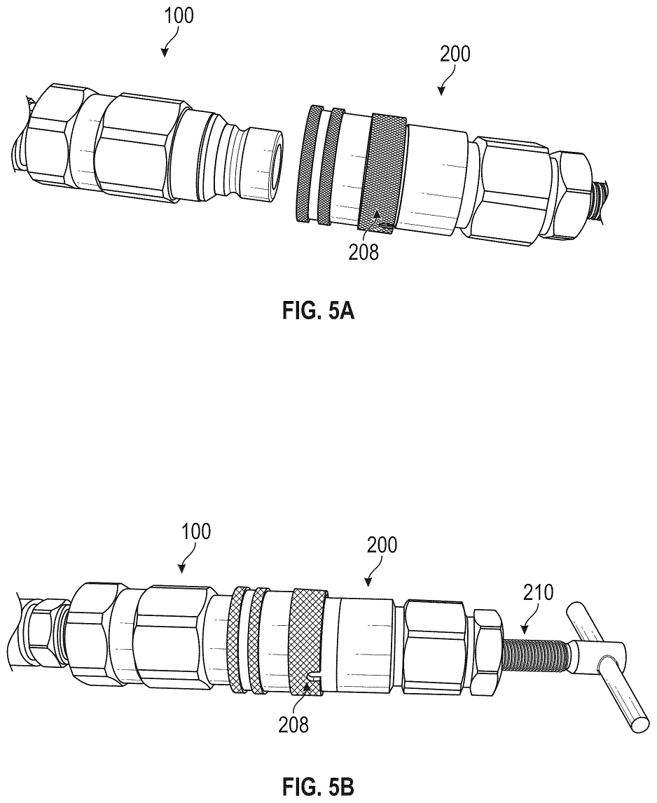

FIG. 5A and FIG. 5B illustrate the tool 200 and male quick coupler 100. As illustrated in FIG. 5A, the tool 200 and male quick coupler 100 separate. As illustrated in FIG. 5A, the sleeve 208 is in a retracted position. In this position the rim 216 of the tool body 202, rim 218 of the sleeve 208, and ring shaped gasket 206 are all flush.

In FIG. 5B, the tool 200 has been engaged to the male quick coupler 100. This is accomplished by pushing the tool 200 onto the neck 105 of the coupler 100. The sleeve 208 slides forward when the tool 200 is engaged to the male quick coupler 100, securely engaging the quick coupler 100. Once the tool 200 and quick coupler 100 have been engaged, as illustrated in FIG. 5B, the threaded plunger 210 can be extended to exert pressure on the center release plug 120. The pressure on the center release plug 120 opens the hydraulic circuit, allowing pressure in the circuit to be released via the bleed port 228.

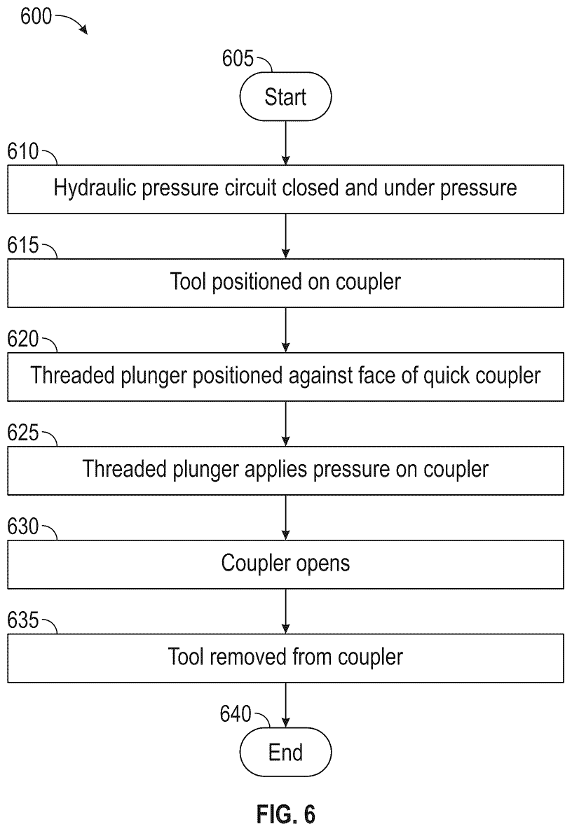

FIG. 6 illustrates a method 600 for opening a coupler, such as quick coupler 100, and releasing pressure in a hydraulic circuit, using a tool 200, in accordance with the disclosed embodiments. The method starts at 605.

At step 610, the hydraulic pressure circuit is closed, and the associated coupler connected to the hydraulic pressure circuit is in a closed position. In this configuration pressure in the hydraulic circuit is maintained, and fluid is prevented from flowing in or out of the coupler.

At step 615, a tool such as tool 200 is positioned on the coupler. In certain embodiments, the tool can be affixed to the coupler by pushing the tool 200 onto the neck of the quick coupler as the tool sleeve slides onto the quick coupler 100 for engagement.

Once the tool is securely engaged, at step 620 the threaded plunger can be positioned against the face of the male quick coupler. This is achieved by turning the threaded plunger so that the plunger head moves toward the center release plug.

At step 625, the plunger head applies pressure to the male quick coupler. In certain embodiments, the plunger head is selected to be smaller in diameter than the center release plug. The plunger head applies pressure against the release plug.

The pressure applied by the tool against the coupler, causes the coupler to open at step 630. In certain embodiments, this can include the release of pressure from the hydraulic circuit, through the bleed port. At step 635 the tool is removed from the coupler, and the method ends at step 640.

Based on the foregoing, it can be appreciated that a number of embodiments, preferred and alternative, are disclosed herein. For example, in an embodiment a tool comprises a tool body, a ring shaped gasket inside the tool body, an internal spring configured inside the tool body configured to exert pressure on the ring shaped gasket, a sleeve operably connected to the tool body, a threaded receiver, and a threaded plunger engaged in the threaded receiver. In an embodiment, the tool further comprises a threaded port formed in the threaded receiver configured to accept the threaded plunger. In an embodiment, the tool further comprises a bleed port form in the tool body. In an embodiment, the tool further comprises a stop peg formed in the tool body. In an embodiment, the sleeve further comprises a peg cutout. In an embodiment, the tool further comprises a series of bearings configured in a ring along an interior circumference of the tool body. In an embodiment, the threaded plunger further comprises a handle attached to a rod. In an embodiment, the rod comprises a threaded section and a plunger head at a distal end. In an embodiment, the tool further comprises a flattened face on an end of the plunger head. In an embodiment, the tool is configured to engage a flat faced ISO 16028 male coupler.

In an embodiment a device comprises a tool configured to engage a flat faced ISO 16028 male coupler, the tool comprising a tool body, a ring shaped gasket inside the tool body, a sleeve operably connected to the tool body, a receiver in the tool body, and a plunger engaged in the receiver. In an embodiment, the device further comprises a threaded port formed in the receiver configured to accept a threaded portion of the plunger. In an embodiment, the device further comprises a bleed port formed in the tool body. In an embodiment, the sleeve further comprises a peg cutout. In an embodiment, the device further comprises a stop peg formed in the tool body. In an embodiment, the device further comprises a series of bearings configured in a ring along an interior circumference of the tool body. In an embodiment, the device further comprises a flattened face on an end of the plunger.

In an embodiment, a tool comprises a tool body, a ring shaped gasket inside the tool body, an internal spring configured inside the tool body configured to exert pressure on the ring shaped gasket, a sleeve operably connected to the tool body, and a threaded receiver. In an embodiment, the tool further comprises a threaded plunger configured to engage the threaded receiver, the threaded plunger further comprising a handle attached to a rod, a threaded section of the rod, and a plunger head at a distal end of the rod. In an embodiment, the tool is configured to engage a flat faced ISO 16028 male coupler.

It will be appreciated that variations of the above-disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

What is claimed is:

1. A tool comprising:
a tool body;
a ring shaped gasket inside the tool body;
an internal spring configured inside the tool body configured to exert pressure on the ring shaped gasket;
a sleeve operably connected to the tool body;
a threaded receiver; and
a threaded plunger engaged in the threaded receiver.

2. The tool of claim 1 further comprising:
a threaded port formed in the threaded receiver configured to accept the threaded plunger.

3. The tool of claim 1 further comprising:
a bleed port formed in the tool body.

4. The tool of claim 1 further comprising:
a stop peg formed in the tool body.

5. The tool of claim 4 wherein the sleeve further comprises:
a peg cutout.

6. The tool of claim 1 further comprising:
a series of bearings configured in a ring along an interior circumference of the tool body.

7. The tool of claim 1 wherein the threaded plunger further comprises:
a handle attached to a rod.

8. The tool of claim 7 wherein the rod comprises:
a threaded section; and
a plunger head at a distal end.

9. The tool of claim 8 further comprising:
a flattened face on an end of the plunger head.

10. The tool of claim 1 wherein the tool is configured to engage a flat faced ISO 16028 male coupler.

11. A device comprising:
a tool configured to engage a flat faced ISO 16028 male coupler, the tool comprising:
a tool body;
a ring shaped gasket inside the tool body;
a sleeve operably connected to the tool body;
a receiver in the tool body; and
a plunger engaged in the receiver.

12. The device of claim 11 further comprising:
a threaded port formed in the receiver configured to accept a threaded portion of the plunger.

13. The device of claim 11 further comprising:
a bleed port formed in the tool body.

14. The device of claim 11 wherein the sleeve further comprises:
a peg cutout.

15. The device of claim 14 wherein the tool further comprises:
a stop peg formed in the tool body.

16. The device of claim 11 further comprising:
a series of bearings configured in a ring along an interior circumference of the tool body.

17. The device of claim 11 further comprising:
a flattened face on an end of the plunger.

18. A tool comprising:
a tool body;
a ring shaped gasket inside the tool body;
an internal spring configured inside the tool body configured to exert pressure on the ring shaped gasket;
a sleeve operably connected to the tool body; and
a threaded receiver.

19. The tool of claim 18 further comprising:
a threaded plunger configured to engage the threaded receiver, the threaded plunger further comprising:
a handle attached to a rod;
a threaded section of the rod; and
a plunger head at a distal end of the rod.

20. The tool of claim 18 wherein the tool is configured to engage a flat faced ISO 16028 male coupler.
